(19) United States
(12) Patent Application Publication
(10) Pub. No.: US 2015/0023634 A1
(43) Pub. Date: Jan. 22, 2015

(54) OPTICAL FIBER CONNECTOR HAVING CLAMPING ELEMENT

(71) Applicant: HON HAI PRECISION INDUSTRY CO., LTD., New Taipei (TW)

(72) Inventor: PO-WEI HUANG, New Taipei (TW)

(73) Assignee: HON HAI PRECISION INDUSTRY CO., LTD., New Taipei (TW)

(21) Appl. No.: 14/093,713

(22) Filed: Dec. 2, 2013

(30) Foreign Application Priority Data
Jul. 19, 2013 (TW) 102126023

(51) Int. Cl. G02B 6/38

(52) U.S. Cl. CPC G02B 6/3881; G02B 6/3889
USPC 385/77

(57) ABSTRACT

An optical fiber connector includes a housing, a number of optical fibers, and a clamping element. The housing includes a top surface and an inner bottom surface, and defines a receiving space extending from the top surface, a number of grooves and a number of clamping holes both extending from the inner bottom surface. The inner bottom surface is adjacent to the receiving space. The optical fibers are received in the grooves. The clamping element is detachably engaged with the clamping holes to fix the optical fibers in the grooves.

### BACKGROUND

1. Technical Field

The present disclosure relates to an optical fiber connector.

2. Description of Related Art

An optical fiber connector includes a housing and optical fibers. The housing defines grooves. The optical fibers are received in the grooves and fixed by cured glue. Yet, when the optical fibers are damaged, the optical fibers cannot be easily replaced because they are fixed by cured glue.

Therefore, it is desirable to provide an optical fiber connector which can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is schematic, isometric view of an optical fiber connector according to an exemplary embodiment of the present disclosure.

FIG. 2 is an exploded view of the optical fiber connector of FIG. 1.

FIG. 3 is a cross-sectional view taken along III-III line of the optical fiber connector of FIG. 1.

FIG. 4 is a cross-sectional view taken along IV-IV line of the optical fiber connector of FIG. 1.

### DETAILED DESCRIPTION

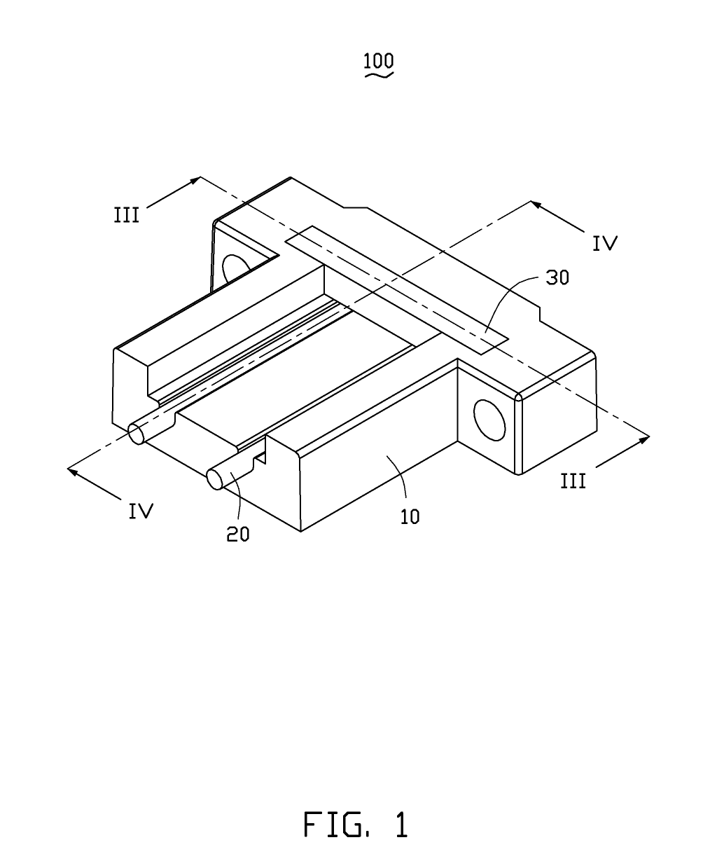

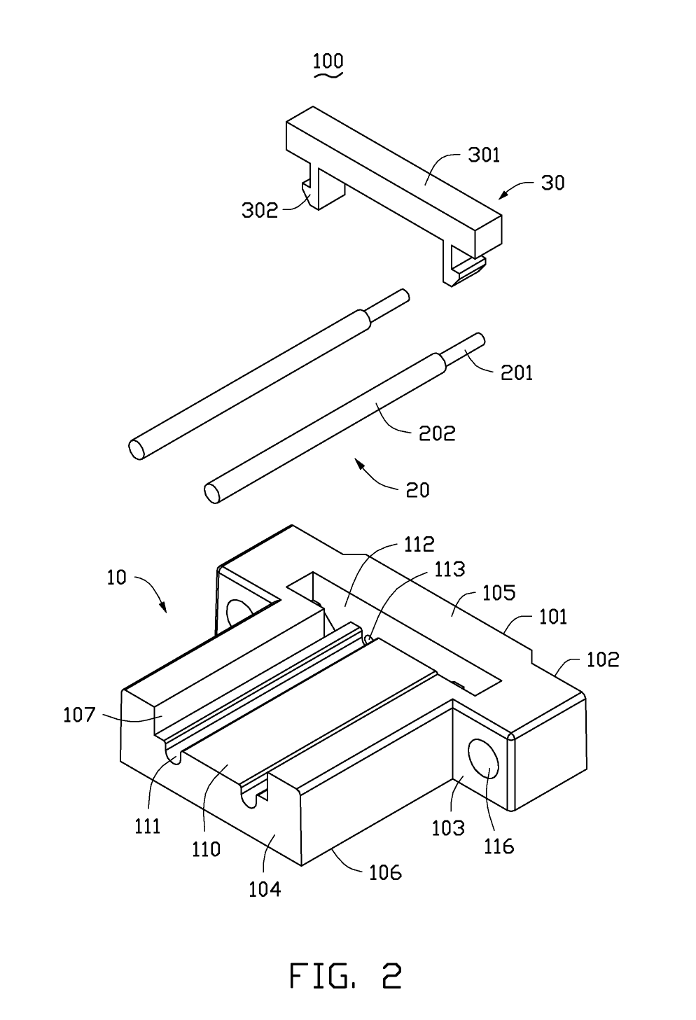

FIGS. 1 and 2 show an optical fiber connector 100 according to an exemplary embodiment of the present disclosure. The optical fiber connector 100 includes a housing 10, optical fibers 20, and a clamping element 30.

The housing 10 is transparent, and is substantially T shaped. The housing 10 includes a first front surface 101, a second front surface 102, a first back surface 103, a second back surface 104, a top surface 105, and a bottom surface 106. The first front surface 101, the second front surface 102, the first back surface 103, and the second back surface 104 are parallel to each other. The first front surface 101 is away from the second back surface 104 relative to the second front surface 102. The second back surface 104 is away from the first front surface 101 relative to the first back surface 103. The top surface 105 and the bottom surface 106 are parallel to each other, and are substantially perpendicular to the first front surface 101, the second front surface 102, the first back surface 103, and the second back surface 104.

The housing 10 defines a receiving space 107 extending from the top surface 105. The receiving space 107 also extends from the second back surface 104 towards the first front surface 101. The receiving space 107 is substantially T shaped. The housing 10 further includes an inner bottom surface 110 and a side surface 112 surrounding the receiving space 107. The inner bottom surface 110 is parallel to the top surface 105. The housing 10 defines grooves 111 at the inner bottom surface 110. The side surface 112 is parallel to the first front surface 101. The housing 10 defines receiving holes 113 extending through the side surface 112 and the first front surface 101. The receiving holes 113 are aligned with the grooves 111. In this embodiment, a cross-sectional view of the groove 111 perpendicular to a longitudinal extending direction of the groove 111 is semi-circular. The receiving holes 113 and the grooves 111 receive the optical fibers 20.

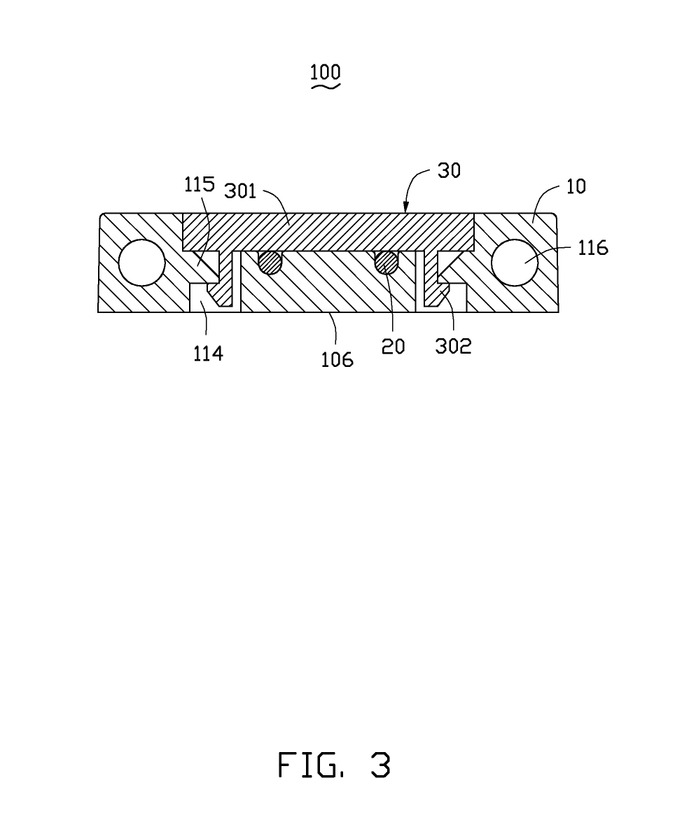

FIG. 3 shows that the housing 10 defines clamping holes 114 extending through the inner bottom surface 110 and the bottom surface 106. The clamping holes 114 are located at an end of the inner bottom surface 110 adjacent to the side surface 112 and are located adjacent to two opposite sides of the grooves 111. The housing 10 further includes wedges 115 projected in the clamping holes 114. The clamping holes 114 and the wedges 115 cooperate with the clamping element 30 to fix the optical fibers 20 in the grooves 111.

The housing 10 further includes a positioning structure 116 for connecting to other optical fiber connectors. In the illustrated embodiment, the positioning structure 116 is a positioning hole extending through the first and second front surfaces 102, 103. In other embodiments, the positioning structure 116 can also be a positioning rod.

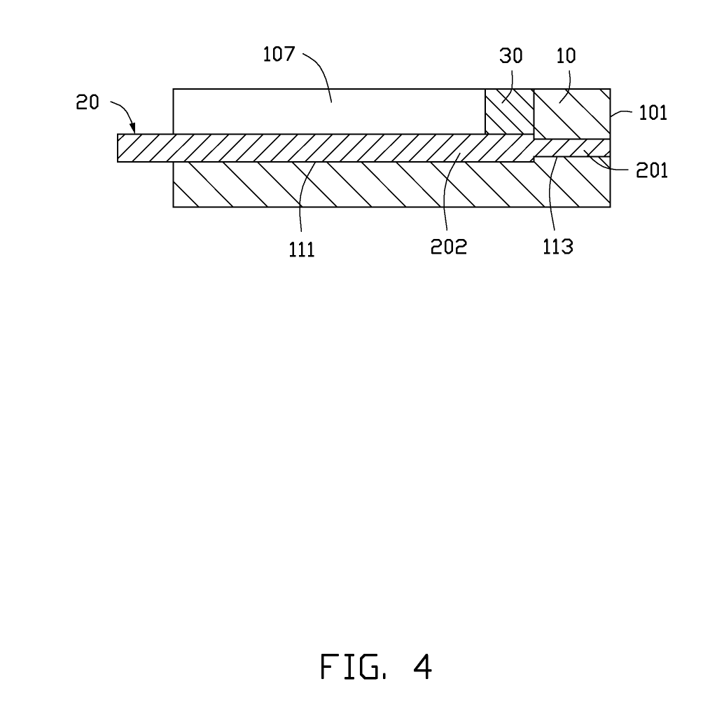

FIG. 4 shows that each optical fiber 20 includes a core fiber 201 and a clapping layer 202 covering the core fiber 201. On an end of the optical fiber 20, the core fiber 201 is exposed and is not covered by the clapping layer 202. A diameter of the core fiber 201 is slightly smaller than a diameter of the receiving hole 113. A diameter of the clapping layer 202 is slightly smaller than a diameter of the groove 111. The clapping layer 202 is received in the groove 111. The exposed core fiber 201 is received in the receiving hole 113.

The clamping element 30 includes a cantilever beam 301 and two hooks 302 perpendicularly extending from the cantilever beam 301. The hooks 302 are substantially

L shaped. The hooks 302 are inserted into the clamping holes 114 and hook the wedges 115 to fix the clamping element 30 on the housing 10. The cantilever beam 301 presses the optical fibers 20 in the grooves 111. As the hooks 302 will be elastically deformed when being inserted into the clamping holes 114, the clamping element 30 is made of material having good toughness, such as polycarbonate (PC).

As the optical fibers 20 are fixed by the clamping element 30, when the optical fibers 20 are damaged, it is easy to detach the clamping element 30 from the housing 10 and replace the optical fibers 20.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. An optical fiber connector comprising:
a housing comprising a top surface and an inner bottom surface, and defining a receiving space extending from the top surface, a plurality of grooves and two clamping holes both extending from the inner bottom surface, the inner bottom surface being adjacent to the receiving space;
a plurality optical fibers received in the plurality of grooves; and
a clamping element detachably engaged with the clamping holes to fix the optical fibers in the plurality of grooves.

2. The optical fiber connector of claim 1, wherein the clamping element comprises a cantilever beam and two hooks extending from the cantilever beam, the two hooks are inserted into the two clamping holes, the cantilever beam pressing the optical fibers.

3. The optical fiber connector of claim 2, wherein the housing further comprises two wedges projected in the two clamping holes and hooking the two hooks.

4. The optical fiber connector of claim 1, wherein the clamping element is made of polycarbonate.

5. The optical fiber connector of claim 1, wherein the housing further comprises a front surface connected to the top surface, and a side surface adjacent to the receiving space and opposite to the front surface, the housing further defines a plurality of receiving holes extending from the side surface towards the front surface, the plurality of receiving holes are aligned and communicated with the plurality of grooves.

6. The optical fiber connector of claim 5, wherein the plurality of optical fibers comprise a plurality of core fibers and a plurality of clapping layers covering the plurality of core fibers, the plurality of core fibers comprises a plurality of exposed ends, the plurality of clapping layers are received in the plurality of grooves, the plurality of exposed ends are received in the plurality of receiving holes.

7. The optical fiber connector of claim 1, wherein the housing further comprises a positioning structure.

8. The optical fiber connector of claim 7, wherein the positioning structure is a positioning hole.

9. The optical fiber connector of claim 1, wherein the housing is transparent.
